(19) United States
(12) Patent Application Publication
(10) Pub. No.: US 2012/0035993 A1
(43) Pub. Date: Feb. 9, 2012

(54) METHOD OF PROVIDING BRAND PROMOTION VIA MOBILE TERMINAL AND THE SYSTEM THEREOF

(76) Inventor: Rajender Kumar Nangia, Uttar Pradesh (IN)

(21) Appl. No.: 13/138,606

(22) PCT Filed: Feb. 26, 2010
(86) PCT No.: PCT/IN2010/000114

§ 371 Date: Oct. 6, 2011

(30) Foreign Application Priority Data
Mar. 9, 2009 (IN) 465/DEL/2009

(51) Int. Cl. G06Q 30/02

(52) U.S. Cl. 705/14.4

(57) ABSTRACT

A method of providing brand promotion via mobile communication terminal comprising a memory unit for storage of data, a display screen for viewing of images comprising the steps of: receiving advertisement image data from a WAP server; storing the advertisement multimedia contents as well as images and voice data in the memory unit; and outputting the advertisement stored in the memory on a predefined application of the mobile phone.

### FIELD OF THE INVENTION

The present disclosure deals with a method of providing brand promotion of articles using mobile phones and the system thereof. More particularly the present disclosure provides an advanced solution for the advertisement through Caller Ring Back Tone, Customized Caller Tone, Customized Video Caller Tone, Video Ring Back Tone, Video Ring Tone, Ring Tone, Pre-Call Audio Message, Dialler Call, During Call in Conference, Video Conference Call, Pre Call Advertisement during Conference Call, Mid Call, Video Message, Wallpaper (Fixed or Sliding), Audio Message, Screen Saver, Scrolling Text, Dialler based IVRS Call, Text Message, Multimedia Messages, 3G/4G Video, SMS, MMS, MIM, Unified messaging, Background music, Hyperlinks, Search Engine, Banner, Mobile Key Pad, Service message LBS (Location Based Service), USSD Message, and Voice message as well as Bluetooth and Wi-Fi in a network. Further the Multimedia—advertising messages are provided to the users in place of ring signals by displaying a selected motion clip on the mobile screen.

### BACKGROUND ART

In this advance era, uses of mobile phones become very common. The mobile phone is an extremely personal device. Today, mobile phones can be utilized for much more than just making and receiving calls. Most commonly, Each and every individual is known about the use of mobiles. People are aware of uses and services that are provided through cell phones. A mobile phone also known as a hand phone, wireless phone, cell phones or cellular phone used for data communication over a network. Mobiles are running through mobile communication terminal. This terminal is a device that allow user to wirelessly connect for performing communication any time and anywhere through controlling of switching by a mobile switching centre (MSC). This terminal also supports multimedia communication including images and videos, as well as data communications including symbols, numbers and characters.

Product suppliers carry out advertisements, i.e., non-personal information providing activities, for the promotion of the sales of the goods and the enhancement of public relations. While traditional advertisement media include television and radio broadcasting, newspapers, and magazines, banner advertisements or insertion advertisements in Internet contents are prevailing nowadays. In particular, short message advertisements utilizing the short message service (herein below, referred to as “SMS”) are emerging as a new advertisement medium recently. [0006] However, the short message advertisement may have some limitations in the advertisement effect. First, a short message transmitted through the SMS is so short that the advertisement sponsor cannot express the message in detail. More basically, since the mobile terminal is an apparatus mainly targeted for personal communication, most users are not interested in junk messages such as the advertisement short messages and likely to delete the messages just after the receipt of the messages. Considering that most advertisement short messages are directed for sales promotion of goods, such phenomenon may disappoint the sponsors.

With the development of high-quality mobile communication terminals, a mobile communication base station provides not only a voice communication service but also various contents such as stock, weather, sports, entertainment and current events, etc. With the increase in terminal usage time and frequency, service providers have sought a method of providing advertisements through the mobile communication terminal. Accordingly, it is possible to provide various advertisements sponsored by advertisers from a mobile communication base station to mobile communication terminal users through a mobile communication network

### SUMMARY OF THE INVENTION

The present disclosure further provides different embodiments and schemes for facilitating the subscriber and the service provider in numerous ways such as herein described by providing the brand promotion of goods with the help of advertisements through mobile communication. The disclosure is therefore related to the brand promotion in different forms and at different times on running any application from the mobile phones of the subscriber.

Multimedia-advertising message is provided to the member users rather than of ring signal and displaying any motion clip on the screen. The given all such things will be advertising materials for registered users as well as non-registered users also. In the current market scenario the mobile users are classified in to two categories as per technology available. The classified categories are Normal Phone with out GPRS—Non 3G/4G, Non Bluetooth and the other categories are Advance Phones—Advanced phones with GPRS, Bluetooth and 3G/4G. The Basic Phones are considered in to Class A, and the Advance Phones are considered as Class B. Further updating of technologies or enhancement in mobile services is continually under consideration.

The objective of present invention is to create an advance and unique platform for providing brand promotion by means of advertisement on basis of division of mobile users. Further, the present invention make available advertisement to users using several ways like caller tone of ringing sound to phone/mobile and many other services regarding multimedia.

The invention is to implement a platform for providing a method of advertisement using a several ways like Caller Ring Back Tone, Customized Caller Tone, Customized Video Caller Tone, Video Ring Back Tone, Video Ring Tone, Ring Tone, Pre-Call Audio Message, Dialler Call, During Call in Conference, Video Conference Call, Pre Call Advertisement during Conference Call, Video Message, Wallpaper (Fixed or Sliding), Audio Message, Screen Saver, Scrolling Text, Dialler based IVRS Call, Text Message, Multimedia Messages, 3G/4G Video, SMS, MMS, MIM, Unified messaging, Background music, Hyperlinks, Search Engine, Banner, Mobile Key Pad, Service message LBS (Location Based Service), USSD Message, and. Voice message as well as Bluetooth and Wi-Fi in a network, and many other commercial services associated to multimedia. The customized advertisement for predetermined time will generate during caller tone without interrupting in user's call. So enable to a caller to listen and watch the customized audio/video advertisement as per his own desire.

The present disclosure further provides different embodiments and schemes for facilitating the subscriber and the service provider in numerous ways such as herein described by providing advertisements in different forms and at different times on running any application from the mobile phones of the subscriber. For acknowledging the facility of providing advertisements, the mobile users are classified into two categories as per the disclosed invention. These categories are Class A (normal phones with Non GPRS and Non 3G) and Class B (Advanced phones with GPRS and 3G/4G). Similar with users, the users will be classified into two categories, first one is registered user second one is unregistered users. The registered users will provide their complete details to the service provider and at any moment they can update their details as well as user categories or service provider can ask for the categories. The registered members will be rewarded with credit points for reading listening of advertisements and get benefit of rewarded points at any moment. Where as the unregistered members can avail the benefits of mobile advertisement services, and will get rewarded for some credit points for using advertisement services, but unregistered user will get benefit of rewarded points after registration.

The aim of this invention is to provide customized advertisement using multimedia features and telecommunication devices and many other commercial services associated to this. Another aim of this invention is to provide various advantages regarding, listening and watching of customized advertisement as per their desire.

The objective of present invention is to create an advance and unique platform for providing advertisement on basis of division of mobile users. Further, the present invention make available advertisement to users using several ways like customized caller tone, customized video ring back tone of ringing sound to phone/mobile and many other services regarding multimedia.

The present invention primarily makes available advertisement with many other facilities associated to it. Therefore, such as herein described a method of providing advertisement via mobile telecommunication terminal comprising a memory unit for storage of data, a display screen for viewing of images comprising the steps of: receiving advertisement image data from a WAP server; storing the advertisement image and voice data in the memory unit; and outputting the advertisement stored in the memory on a predefined application of the mobile phone.

The advertisements are in the form of Caller Ring Back Tone, Customized Caller Tone, Customized Video Caller Tone, Video Ring Back Tone, Video Ring Tone, Ring Tone, Pre-Call Audio Message, Dialler Call, During Call in Conference, Video Conference Call, Pre Call Advertisement during Conference Call, Video Message, Wallpaper (Fixed or Sliding), Audio Message, Screen Saver, Scrolling Text, Dialler based IVRS Call, Text Message, Multimedia Messages, 3G/4G Video, SMS, MMS, MIM, Unified messaging, Background music, Hyperlinks, Search Engine, Banner, Mobile Key Pad, Service message LBS (Location Based Service), USSD Message, and Voice message as well as Bluetooth and Wi-Fi in a network.

in caller tune, the method is configured such that one can hear particular CCT, like advertisement, mantra, dialogue, songs, movie and trailers on particular number in the customized format. If any particular CCT likes any specific advertisement, song, dialogue, mantra, movie, trailer etc. are not available in the marketplace then in that case user can download this ring tone and convert it into CCT (Customized Caller Tone) by pressing # (hash) or any specific key. Instead of it, any one can change any CCT to ring tone. The CCT can be advertising data or his own desire data like song, video clip, a note and so on.

The aim of this invention is to provide customized advertisement using multimedia features and many other commercial services associated to this. Another aim of this invention is to provide various advantages regarding listening and watching of customized advertisement as per their desire.

It is another feature of the present invention is to make available advertisements (multimedia) and customize them as per the requirement. However it will help the advertisers to provide right data for right person or needful person. For Example—I sugar patient can customize their caller ring back tone/ring tone, CCT as sugar medicines ads.

This invention is related to play an audio/video/text advertisement through mobile. and play multimedia clip and background music on mobile phones as an advertisement when user commence a call with their mobile terminals, and the user will get valuable information through the advertisement while placing a call to any number. Invention will also provide advertisement as played may be audio/video, text or both. As per another feature of the invention to provide a customized advertisement through playing music and sound in background when someone places a phone call.

The method of advertisement to the mobile users through various ways like through Caller Ring Back Tone, Customized Caller Tone, Customized Video Caller Tone, Video Ring Back Tone, Video Ring Tone, Ring Tone, Pre-Call Audio Message, Dialler Call, During Call in Conference, Video Conference Call, Pre Call Advertisement during Conference Call, Video Message, Wallpaper (Fixed or Sliding), Audio Message, Screen Saver, Scrolling Text, Dialler based IVRS Call, Text Message, Multimedia Messages, 3G/4G Video, SMS, MMS, MIM, Unified messaging, Background music, Hyperlinks, Search Engine, Banner, Mobile Key Pad, Service message LBS (Location Based Service), USSD Message, and Voice message as well as Bluetooth and Wi-Fi in a network. The present invention primarily makes available advertisement with many other facilities associated to it.

Therefore, such as herein described a method of providing advertisement via mobile communication terminal comprising a memory unit for storage of data, a display screen for viewing of images comprising the steps of: receiving advertisement image data from a WAP server; storing the advertisement image and voice data in the memory unit; and outputting the advertisement stored in the memory on a predefined application of the mobile phone.

Another exemplary embodiment of the present invention is to provide a facility to a user wherein the statistical details in regard with the advertisement is recorded, like how many times the advertisement play on a particular number in a day for how much duration it plays and to display the details of total duration of particular advertisement to the user and/or the service provider.

BRIEF DESCRIPTION OF THE ACCOMPANYING DRAWINGS

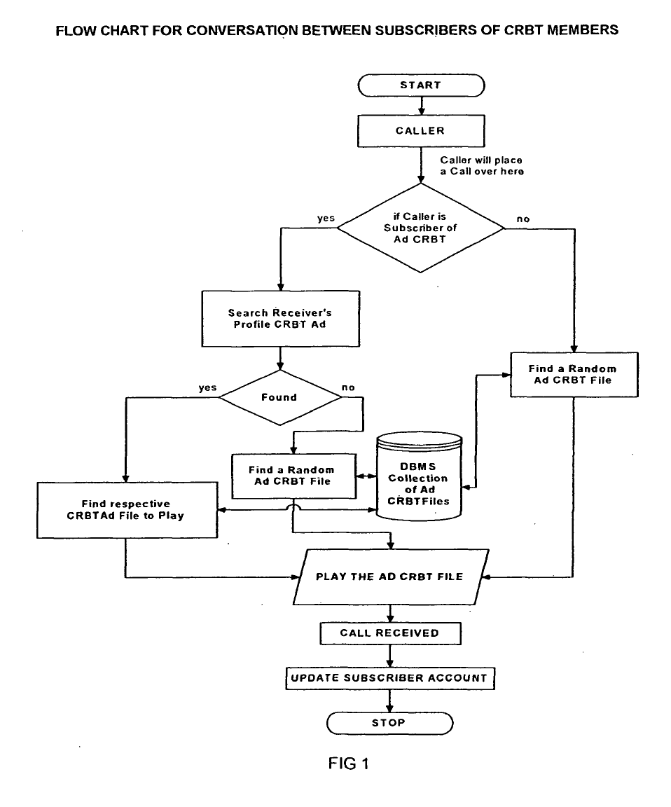

FIG. 1, illustrates the flow chart for conversation between subscribers of CRBT members in accordance with the present invention;

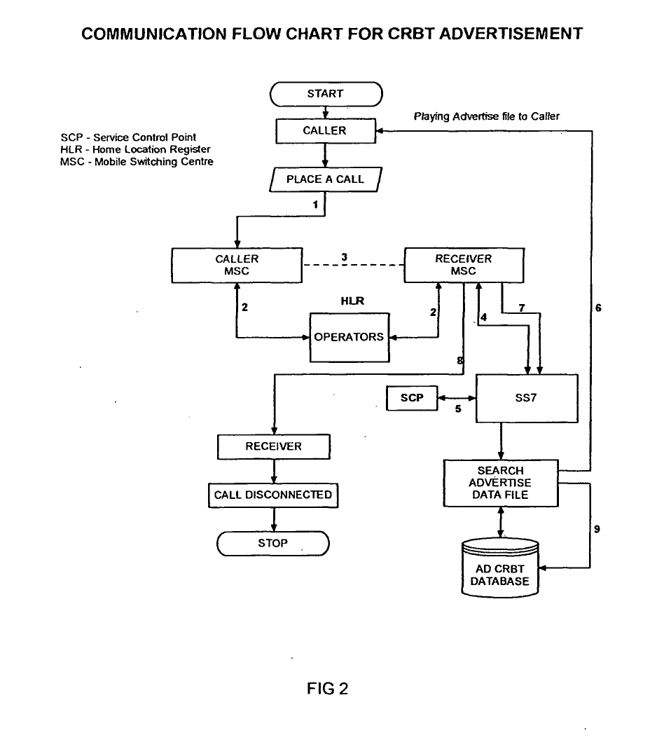

FIG. 2, illustrates the communication flow chart for CRBT advertisement in accordance with the present invention;

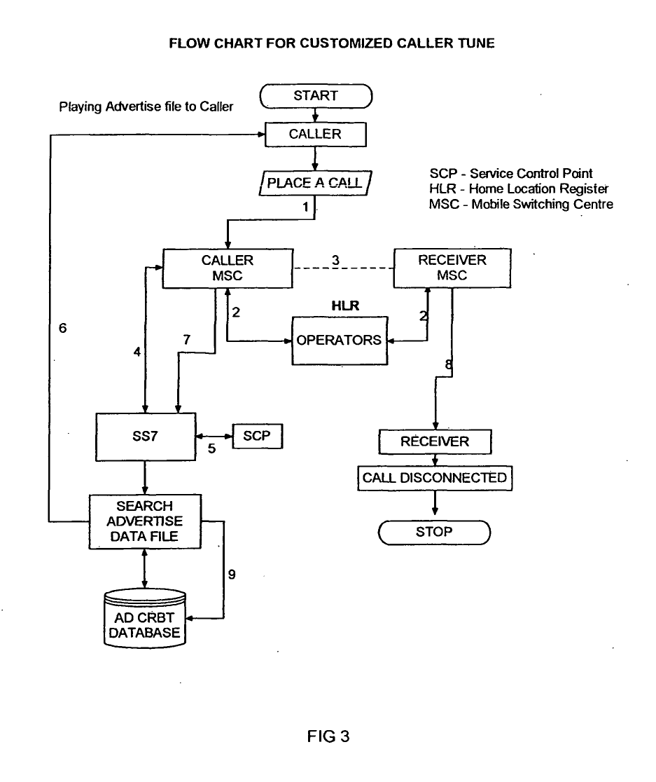

FIG. 3, illustrates the flow chart for customized caller tune in accordance with the present invention;

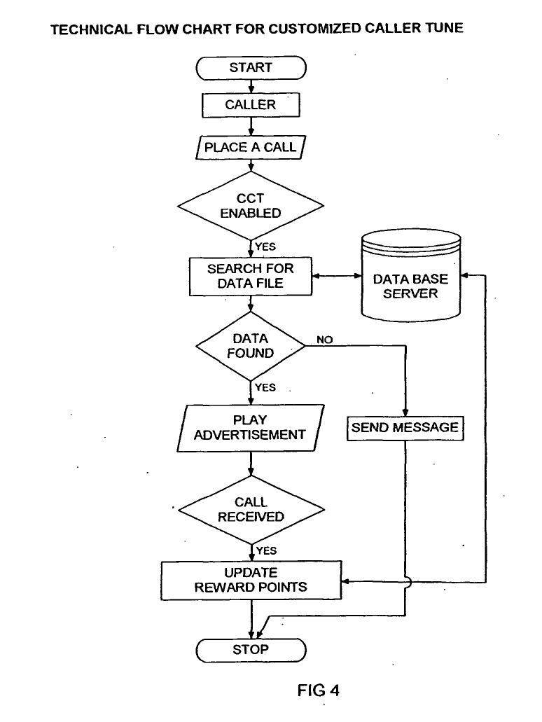

FIG. 4, illustrates the technical flow chart for customized caller tune in accordance with the present invention;

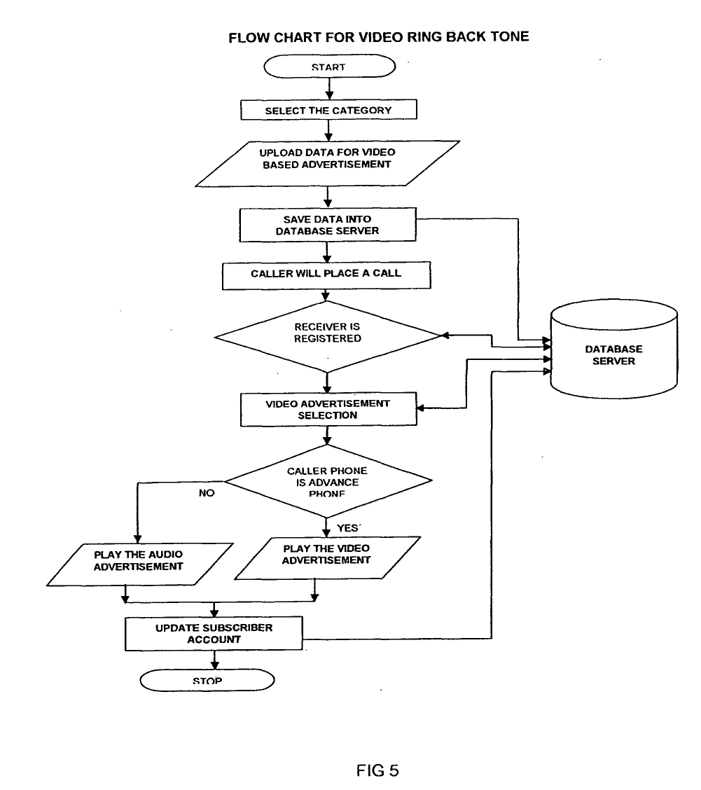

FIG. 5, illustrates the flow chart for video ring back tone in accordance with the present invention;

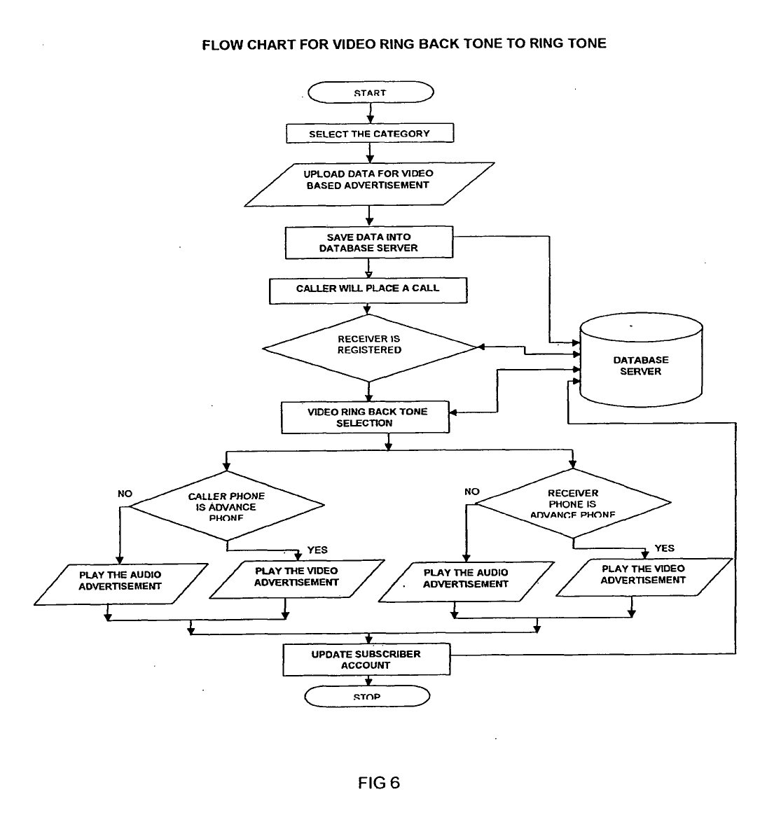

FIG. 6, illustrates the flow chart for video ring back tone to ring tone in accordance with the present invention;

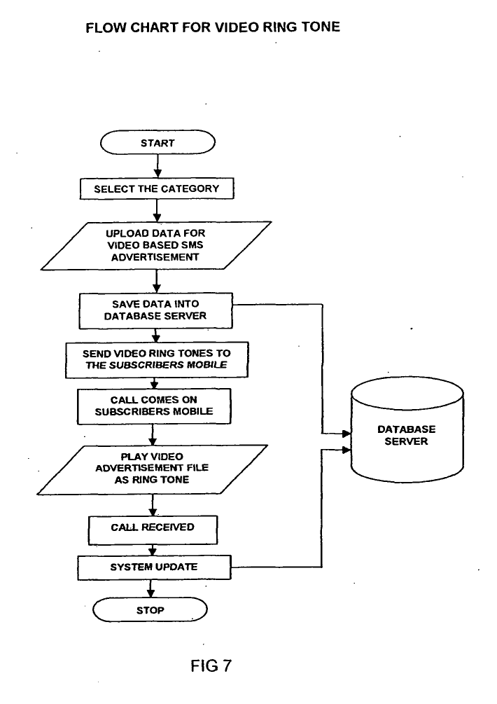

FIG. 7, illustrates the flow chart for video ring tone in accordance with the present invention;

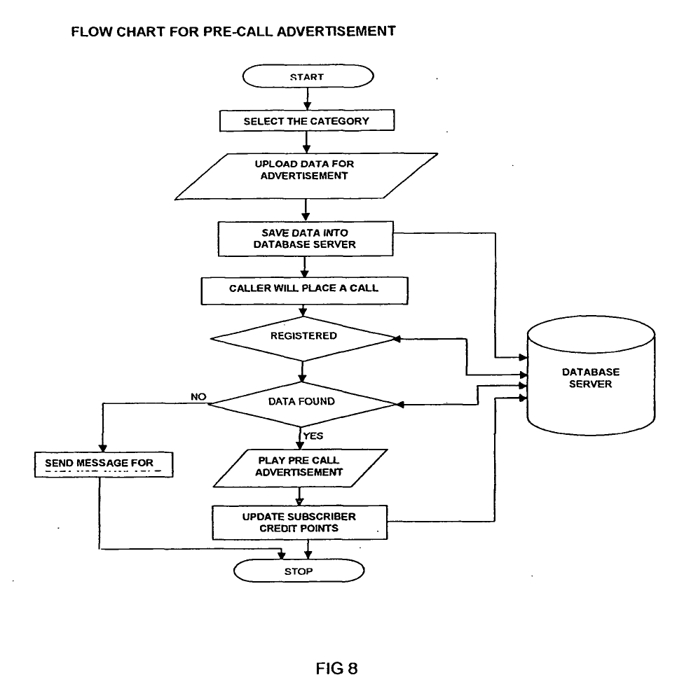

FIG. 8, illustrates the flow chart for pre-call advertisement in accordance with the present invention;

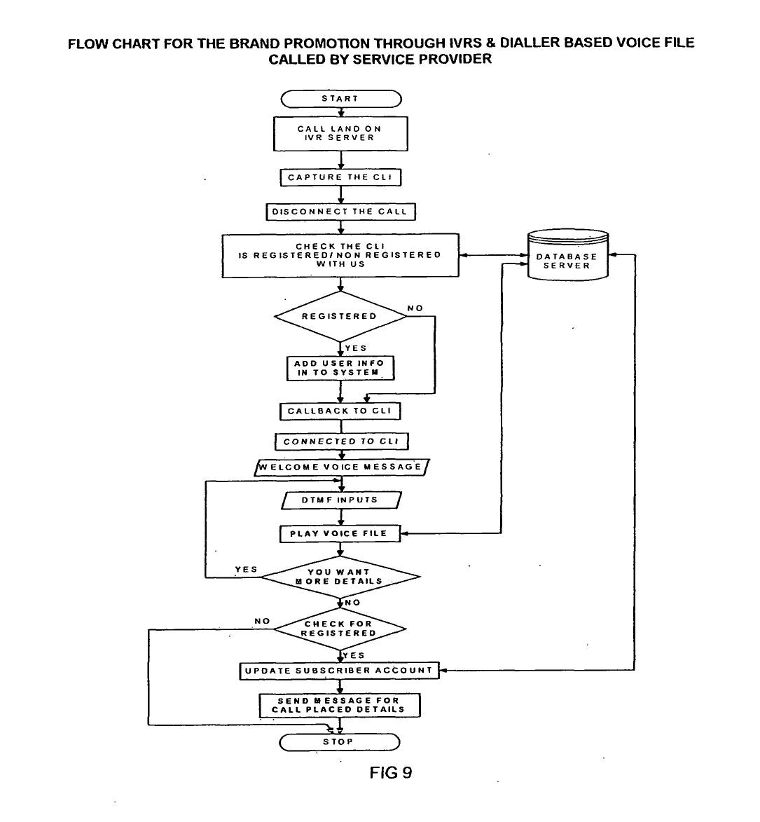

FIG. 9, illustrates the flow chart for the brand promotion through IVRS & dialler based voice file called by service provider,

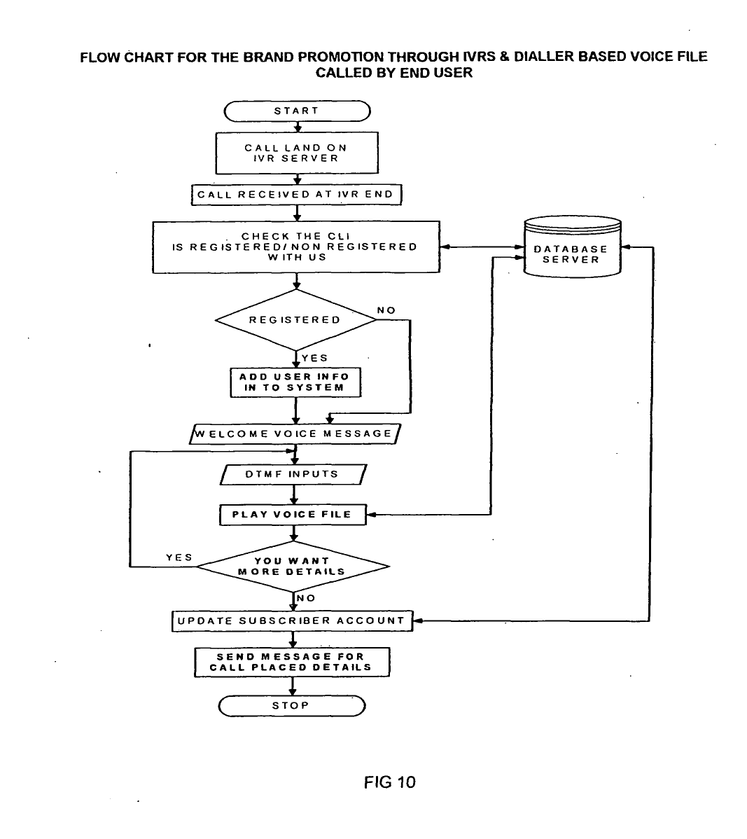

FIG. 10, illustrates the flow chart for the brand promotion through IVRS & dialler based voice file called by end user in accordance with the present invention;

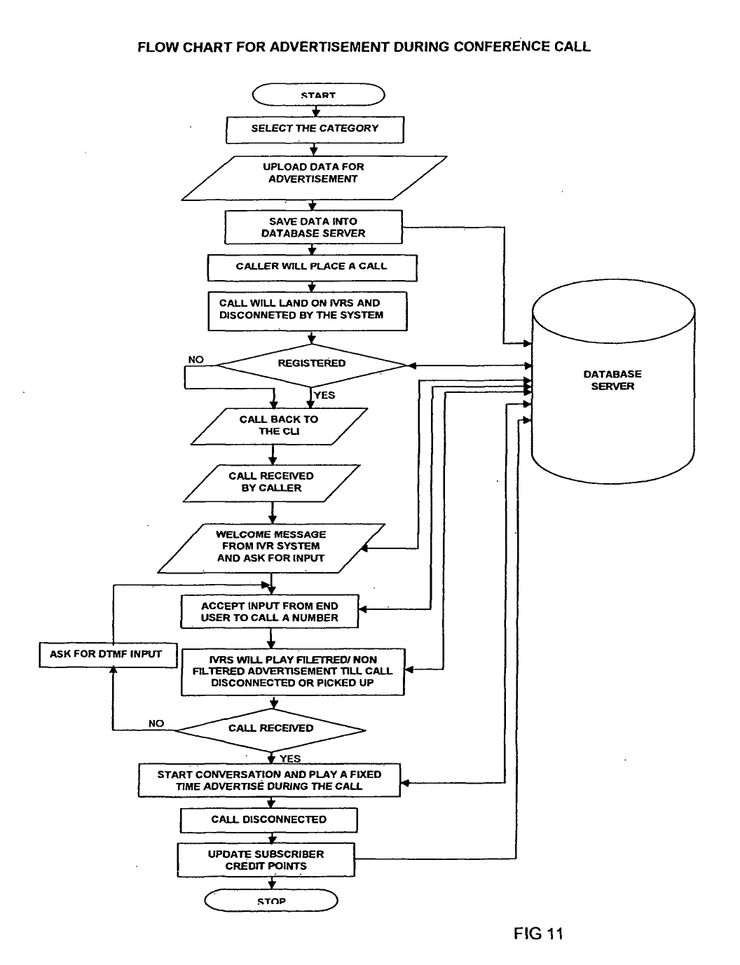

FIG. 11 illustrates the flow chart for advertisement during conference call in accordance with the present invention;

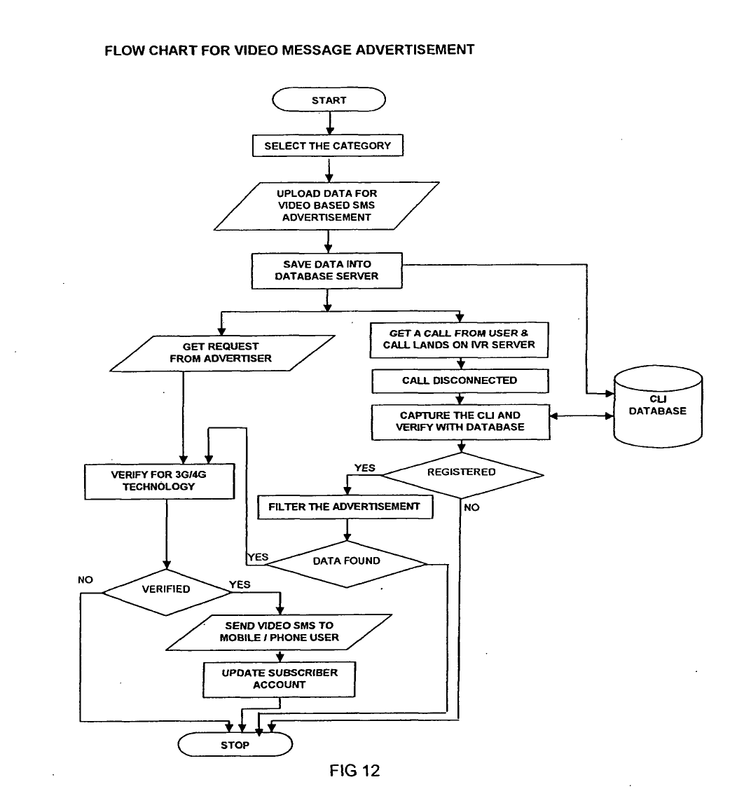

FIG. 12 illustrates the flow chart for video message advertisement in accordance with the present invention;

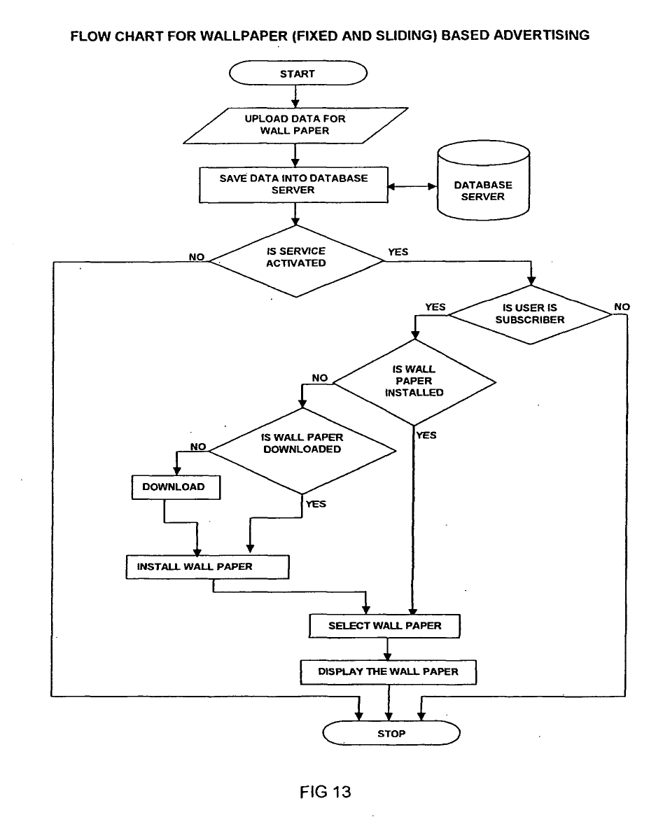

FIG. 13, illustrates the flow chart for wallpaper (fixed and sliding) based advertising in accordance with the present invention;

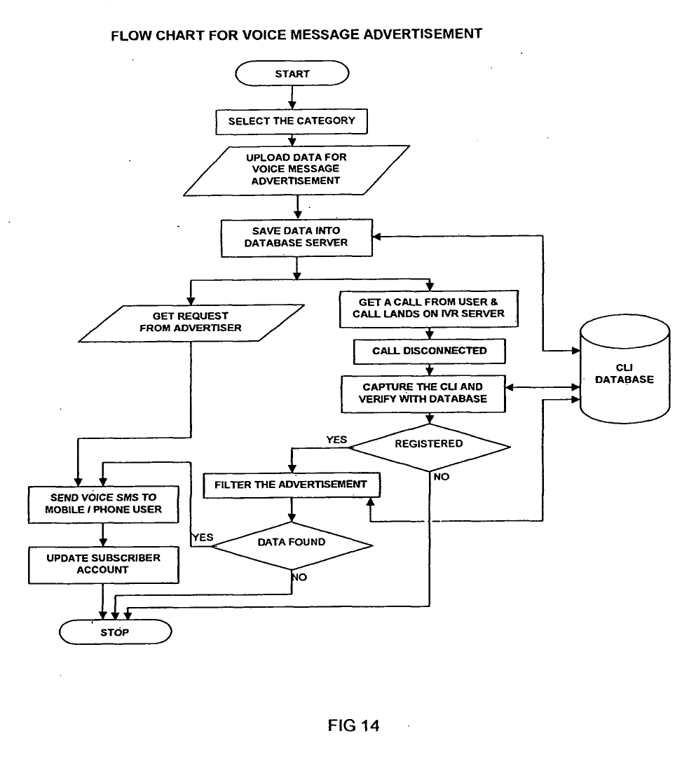

FIG. 14, illustrates the flow chart for voice message advertisement in accordance with the present invention;

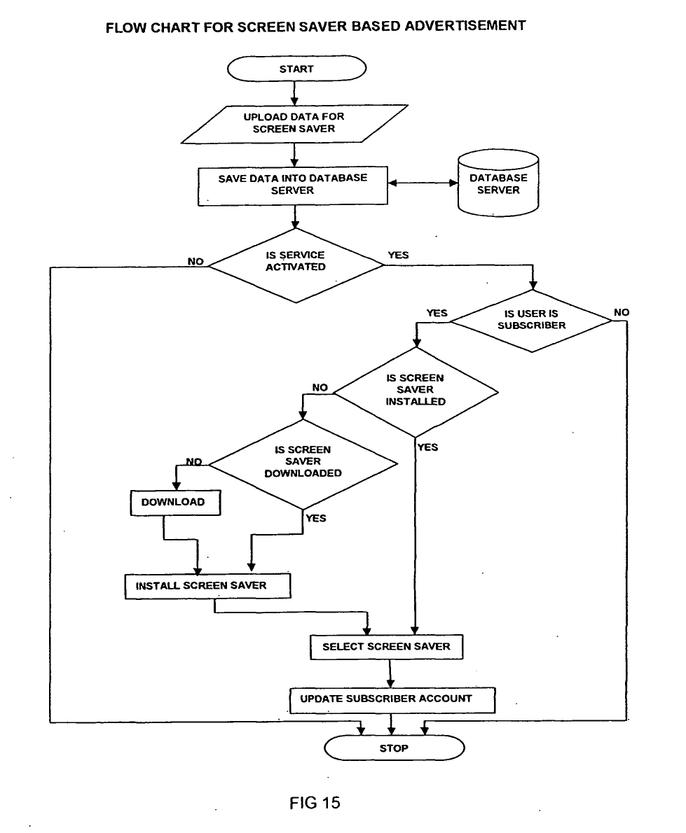

FIG. 15, illustrates the flow chart for screen saver based advertisement in accordance with the present invention;

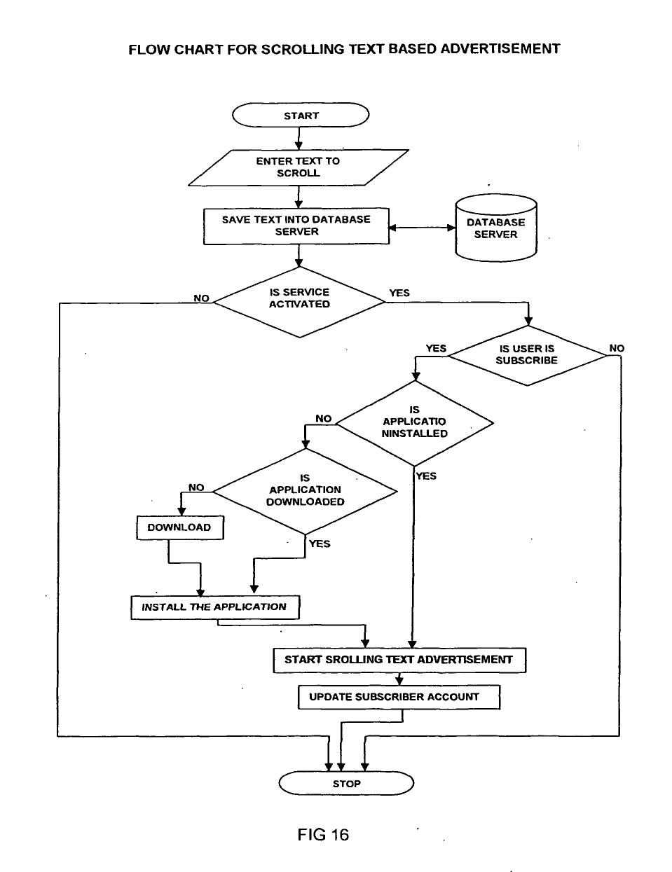

FIG. 16, illustrates the flow chart for scrolling text based advertisement in accordance with the present invention;

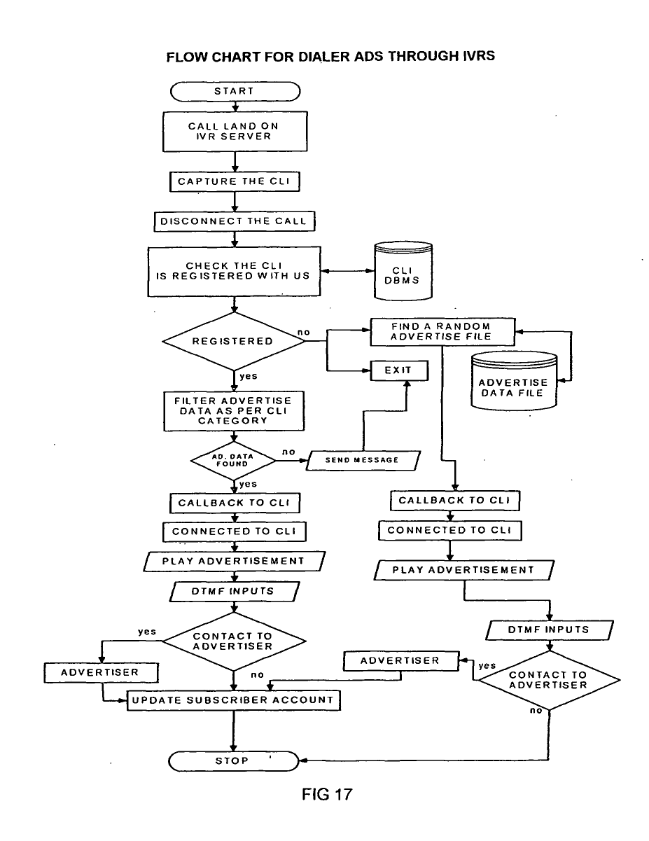

FIG. 17, illustrates the flow chart for dialler ads through IVRS in accordance with the present invention;

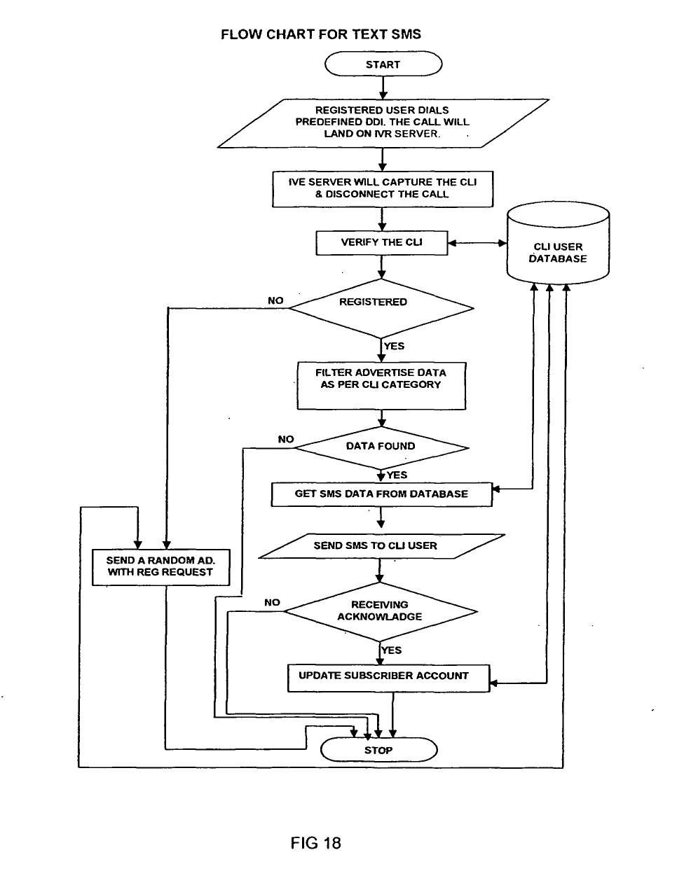

FIG. 18, illustrates the flow chart for text SMS in accordance with the present invention;

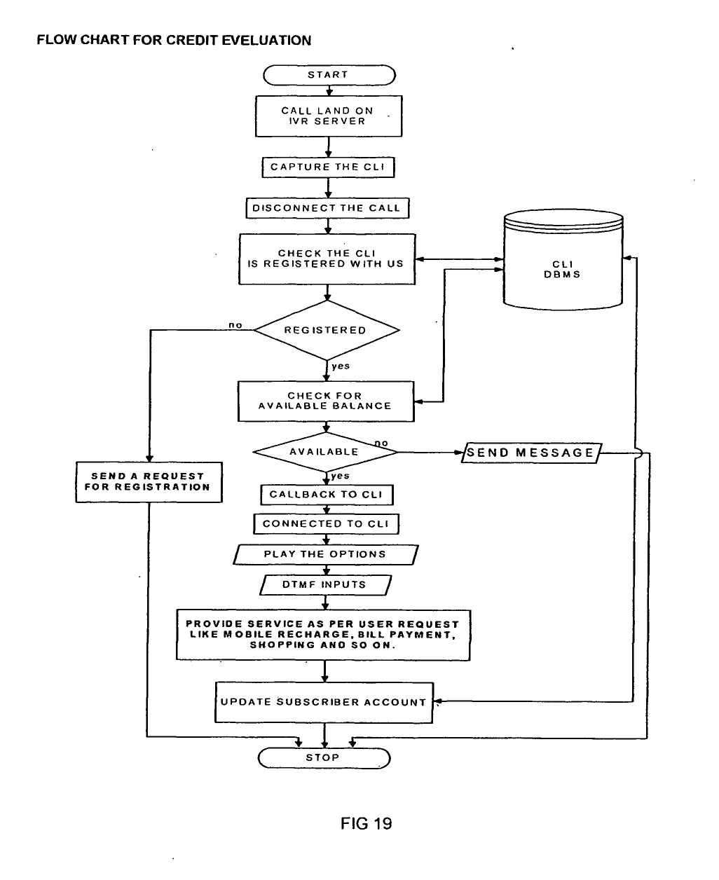

FIG. 19, illustrates the flow chart for credit evaluation in accordance with the present invention;

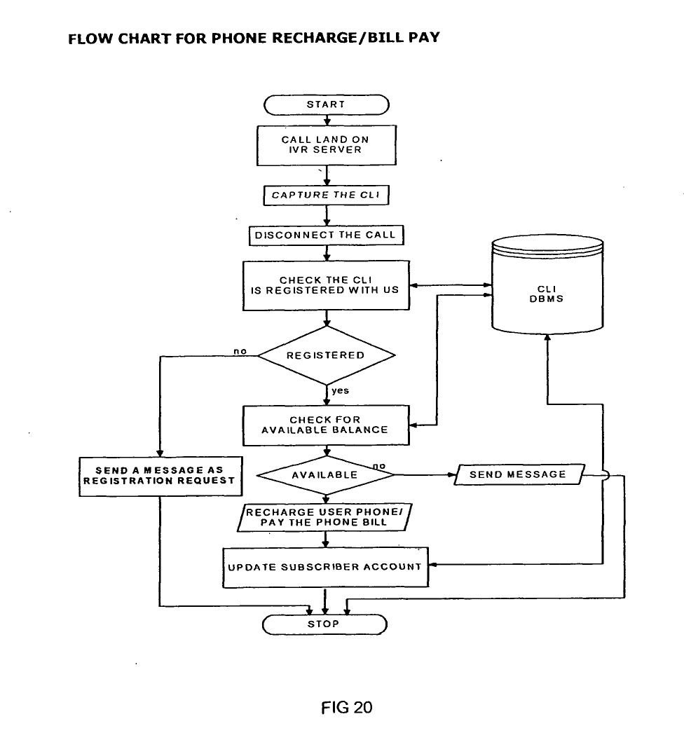

FIG. 20, illustrates the flow chart for phone recharge/bill pay in accordance with the present invention;

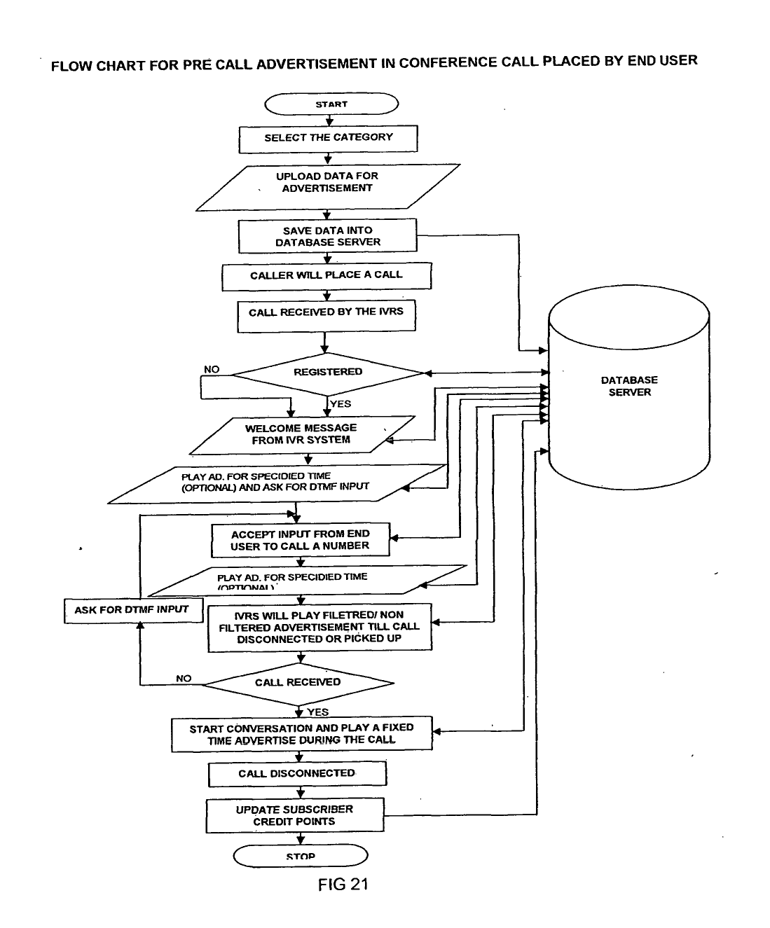

FIG. 21, illustrates the flow chart for pre call advertisement in conference call placed by end user in accordance with the present invention;

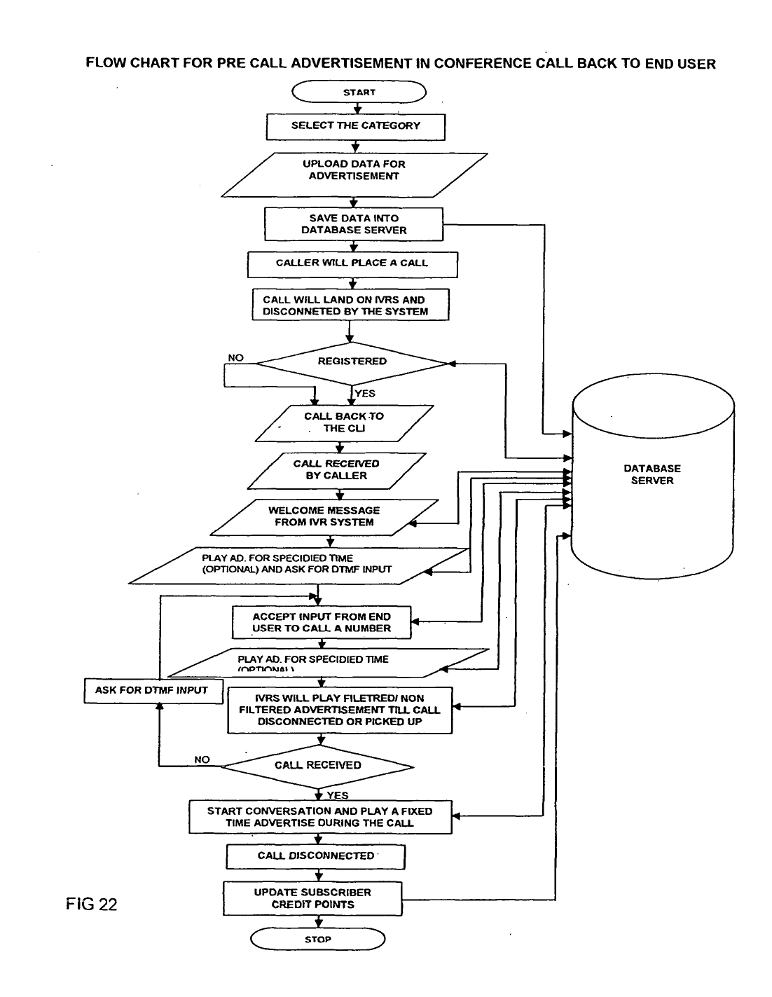

FIG. 22, illustrates the flow chart for pre call advertisement in conference call back to end user in accordance with the present invention;

### DETAILED DESCRIPTION

The present invention is based on the latest and new scheme of caller tone advertising. There are many types of unique schemes under the advertising schemes but one of the different and fresh ideas is of providing advertisement through caller tone. This concept will provide the advertisement, so that user may listen and watch this clip during call. These advertisements are available at lower price. User may avail various benefits through such advertisements. Moreover, these advertisements will be intensifying in effective manner. These advertisements will be provided to each individual user, according to their own requirement.

### Customized Caller Tune

The CCT refers to Customized Caller Tune; this concept of ours is completely unique and fresh. Here, our new concept of customized caller tune is as such when a caller member will call on specific contact number (receiver) and caller members is the member of customize caller tune, then the caller member can hear the customized advertisement, on that particular number as per his own desire. Through this new concept customer need not to hear all time same ring back tone, they can hear advertisement of their own choice, it is not caller ring back tone, In the CRBT the caller listen the ring tone select at receiver end, but in CCT the caller will listen the ring tone selected at caller end. In the CCT the caller can select different ring tones for different numbers. The objective of present invention deals in the field of advertisement using mobile phones. It provides a unique platform to the registered users, so they can hear specific customized advertisement.

The main objective of present invention is to provide enhancement in the field of advertisement using mobile phones. It will provide a unique and secure platform to the users, for hearing customized advertisement as per their own desire.

Before this concept, ring back tone was in marketplace. Caller subscribes the service and ring back was listen by caller which was enabled at receiver end, but this concept is completely opposite of CRBT and according to this concept caller can subscribe this service and listen advertisement of their own choice and avail all benefits on its own.

With the development of high-quality mobile communication terminals, a mobile communication base station provides not only a voice communication service but also various contents such as stock, weather, sports, entertainment and current events, etc. With the increase in terminal usage time and frequency, service providers have sought a method of providing advertisements through the mobile communication terminal. Accordingly, it is possible to provide various advertisements sponsored by advertisers from a mobile communication base station to mobile communication terminal users through a mobile communication network.

For the audio/video advertisement when a caller will place a call to the network, the customized caller tone audio/video file will be played and caller will listen/watch the caller tone defined/customized by the caller and stored at server, before playing the audio/video advertisement in caller tone the system will verify the CLI and search for the customized advertise (as per category criteria defined by caller) data. The advertise data can be dialogues, songs, movie trailers or any video/audio file. Caller can listen/watch advertisement of their own choice. After completion of audio/video advertisement the status will be updated for caller if registered. In the CCT the caller will hear the filtered advertise data. The caller to CCT enabled user will not be able to know which advertisement the receiver has selected. And the caller will not feel any hesitation for enabling the CCT and hear the filtered data as per their need for example—a caller is the vegetarian and sugar patient, then the system will play only related on their caller tone as per their selected category. The caller will be rewarded by credit points for hearing the advertisements.

### Dialler Based Advertisement

Dialler Ads is basically an advertisement scheme for mobile/phone users. The mobile user will get advertisement calls from the system. The registered mobile/phone user will get filtered advertise data while receiving the calls, and unregistered mobile/phone user will get non filtered data calls. The advertise data can be Text based and audio/video message for dialler ads. The end user will get rewarded for reading and listening/watching of advertisement on mobile. This System will provide various types of advertisement.
1. Text Message
2. Video Message
3. Dialler based Audio Ads.
4. Voice message.

For the text message the registered mobile user will dial a predefined number ######, after dialling this number by mobile user when the call touch to the IVR server, the server will capture the CLI and disconnect the call, after that system will verify the mobile number and search the respective advertise (as per category criteria defined by mobile user) and after verification the system will send some advertisement SMS to that CLI number if registered only than filtered data will be send otherwise the random advertise data will be send on the request for unregistered user. After getting the response of that advertisement message from mobile user, it will credit some reward points to the mobile user account.

For the video message the registered mobile user will dial a predefined number ######, after dialling this number by mobile user when the call touch to the IVR server, the IVR server will capture the CLI and disconnect the call, after that system will verify the mobile number and search the respective advertise (as per category criteria defined by mobile user) and will send some advertisement video message data file to that CLI number, if registered only than filtered data will be send otherwise the random advertise data will be send on the request. After getting the response of that advertisement message from mobile user, it will credit some reward points to the mobile user account.

For the voice message the registered mobile user will dial a predefined number ######, after dialling this number by mobile user when the call touch to the IVR server, the server will capture the CLI and disconnect the call, after that system will verify the mobile number and search the respective advertise (as per category criteria defined by mobile user) and will send some advertisement voice message data file to that CLI number, if registered only than filtered data will be send otherwise the random advertise data will be send on the request. After getting the response of that advertisement message from mobile user, it will credit some reward points to the mobile user account.

For the Dialler based audio advertisement the register user will dial a predefine number ######, after dialling this number by mobile user when the call touch to the IVR server, the server will capture the CLI and disconnect the call, after that system will verify the mobile number, If the CLI is not verified than either it will terminate the request, or select a random advertisement and dialler will dial the number for call back to the CLI, so the CLI user will be able to hear the advertisement, else If verified than it will search the respective advertise (as per category criteria defined by mobile user) if advertise data not found than it will send an SMS to the CLI, else if found than the dialler will dial CLI number for call back, and after receiving the call the IVRS will play the respective audio advertisement. If the CLI user wants to connect to advertiser then caller can connect to advertiser and resolve their query from advertiser. After completion of dialler call to play the audio advertisement the IVR Server will pass a status of call completion and the respective engine will update member account with some reward points.

For the Reward Point evaluation the registered user will dial a predefined number ######, after dialling this number, the user will follow the instruction and provide DTMF inputs, after that the member will buy the desired thing from his own desire with respective to available reward points in their account. e.g.—after dialling ###### number user will get their account information like available reward points and will have option to purchase what ever available. When balance will available, the user can use these rewards points for shopping, bill payments and so on.

As per the functionality of customized advertisement, the advertiser will generate the audio/video advertisement and upload that advertisement to the system, so the uploaded data will be available to the callers registered/unregistered. The uploaded data can be in audio format, video format, text based as well as manipulated text, audio/video file. For manipulation the system will help to the advertiser to add background music it to their advertisement. Here the advertiser will select the background music and having right to mix this background music into their advertisement, so the advertisement will become more attractive, the advertiser will select a Background music from the system and download that and mix their advertisement with that background music and upload that advertisement file or the advertiser can mix the background music with their advertisement by using microphone through internet, so the advertiser will get benefit for creating advertisement from the market. And the advertiser can upload multiple advertisement files into the system. So the system will upload these files into their account, and the system will store this information as per the advertiser details. The advertiser can upload or modify their advertisement till the balance available in the system. After expiration of balance the system will not allow the advertiser to upload any advertise data file

The several ways of providing advertisements are as follows:
1. Hyperlink advertisement
2. SMS text advertisement
3. Scrolling text
4. Screen saver
5. Caller tune
6. Ring tone
7. 3G Video
8. Wallpaper (Fixed and Sliding)
9. Precall ads
10. Background music
11. LBS (Location Based Service)
12. Voice message
13. Dialler ads
14. Search engine
15. Display e.g. banners

Now we will discuss in detail the different applications wherein the brand promotion is provided through mobile advertisements for the different applications as set out during the use of a mobile. Also the method for providing the mobile advertisements as described by the referred flowcharts are explained in detail below:

### Method for the Conversation Between Subscribers of CRBT Members

With reference to FIG. 1, while communicating between two members of Ad CRBT, if the receivers CRBT Ad category matches with callers profile CRBT Ad category than the caller will hear CRBT Ad, which matched with his profile CRBT Ad Category instead of default random CRBT Ad. The CRBT Ad is played on the basis of availability, if available than matching profile CRBT Ad will play else a random CRBT Ad is played. Here it is necessary that receiver must have enabled the CRBT Ad on their mobile/phone. The CRBT Ad is played till the call is received; at the moment of call received a request is generated and processed for updating the receiver account.

### Method for Communication for CRBT Advertisement

With reference to FIG. 2, the CRBT plays an advertisement to the Caller as per requested by Receiver or Service Provider. For running the CRBT the receiver must be a member of CRBT Ad service. First the Caller places a call over the Network (1), after that the call hits to the Caller Message Switching Centre, as per the number the MSC finds the Home Location Register (2) for (where the receiver number registered.) From the HLR the call is transferred to the Receiver MSC (3). At the end of receiving MSC it hits to the SS7 Layer (4) and verify for the membership of CRBT through SCP (5). If the receiver is the member of CRBT Ad service then it searches for Advertise Data and play the advertise file to the Caller (6). In this step the receiver phone continues ringing and the advertisement is played at caller end till the receiver did not pick the phone call. When receiver presses the receive button a response is sent to receiving MSC (7) and the playing advertisement file is stopped, and the call is connected to receiver (8). At the time of call connected the Advertisement number, time duration of ad played, and number of advertisement files if more than one played, playing date and time will be updated in to database (9) for further use. After disconnected the phone call from either receiver or caller the conversation is stopped.

### Method for the Brand Promotion by Customized Caller Tune

With reference to FIG. 3, the CCT plays an advertisement to the Caller as per requested by Caller at Caller Service Provider end. For running the CCT the caller must be a member of CCT Ad service. First the Caller places a call over the Network, after that the call hits to the Caller Message Switching Centre, as per the number the MSC, when the call reaches to the Caller message switching centre, the caller MSC checks the Number for enabled the customized Caller Tune (CCT) as well as it hits to the Receiver Message Switching Centre, if the CCT enabled on the caller number then it plays the advertisement on caller mobile till call not received. When the caller MSC gets the response for call connected, at the same time the caller MSC stops the caller CCT and receiver and caller start conversation and after that the call is disconnected by either caller or receiver.

### Method for Providing Customized Caller Tune to the Users

Referring FIG. 4, the CCT enabled caller places a call to the network, after placing the when the call hit to the message switching centre (MSC), it checks for the enabling the CCT, after checking enabled or not, if enabled then it further checks for the data available if data is available then the system plays the customized advertisement as the customized caller tune to the caller. If the data is not available then it will send the message to the caller. After receiving the call the system stops the CCT and updates the reward points to the caller account.

### Method for Providing Video Ring Back Tone

On referring to FIG. 5, the advertiser uploads the video advertisement as per the category suitable for their business. This uploaded data is saved into database server, when the caller places a call then the system checks for the availability of advertisement video file if available then it sends signals to the caller MSC, if the caller mobile is advance phone then the advertisement video file is played on caller mobile else the normal audio caller tune is played at caller end. After receiving the call, the system updates the database to credit the reward points.

### Method for Converting the Video Ring Back Tone to Ring Tone

With reference to FIG. 6, the advertiser uploads the video advertisement as per the category suitable for their business. This uploaded data is saved into database server, when the caller places a call then the system selects the advertisement video file, after that it sends signals to the caller MSC, if the caller mobile is advance phone then the advertisement video file is played on caller mobile else the normal audio caller tune is played at caller end. If the receiver phone is advance phone, and he is the subscriber of video ring tone then the video ring tone is on receiver phone, else if receiver phone is normal phone then the normal ring tone will be played. After receiving the call, the system updates the database to credit the reward points

### Method for Providing Video Ring Tone

With reference to FIG. 7, In the current system the process again starts from advertiser end, the advertiser uploads the data as per the category suitable to their business; the uploaded data is stored into system, after saving the ring tone into system the system sends this advertisement video ring tone file to the subscriber mobile. When a call come the subscriber then the advertisement video file is played. If the subscriber remove the advertisement video file then it will automatically stored again till the subscriber does not remove their subscription for this service. After receiving the call, the advertisement video ring tone is stopped automatically and the system updates reward credit points.

### Method for Providing Pre-Call Advertisement

With reference to FIG. 8, In the current system, the advertiser uploads the audio advertisement as per the category suitable for their business. This uploaded data is saved into database server, in this system when a user place a call then the system verify the caller that caller is the subscriber then it checks for the data availability if data available only then the system plays an advertisement at caller end, else if data not found then it send a message for data not found and the call will be forwarded to the receiver message switching centre. After playing the advertisement file the system will update the database to credit the subscriber reward points.

### Method for Providing the Brand Promotion Through IVRS & Dialler Based Voice File Called by Service Provider

As referred in FIG. 9, the method for the brand promotion through IVRS & Dialler based voice file is illustrated, wherein the end user has to dial the number to the service provider, when the call touches to the service provider IVR system, the IVR system captures the CLI and disconnect the call and the dialler dials the said number to call back, when the call is being received by caller then the IVR plays a welcome message and ask for DTMF inputs, the audio file is played according to the provided input, the system asks for more DTMF inputs for more details and exit, for more information the end user provides DTMF input and for exit also it provides the input, if the end user is not providing any input then the IVR waits for a specified time and update the reward points & the call is disconnected. While providing DTMF inputs the system, when the user provides input to exit then the system updates the credit points and disconnect the call.

### Method for Providing Brand Promotion Through IVRS & Dialler Based Voice File Called by End User

With reference to FIG. 10, the end user has to dial the number to the service provider, and the call is received by IVR server, then the IVR plays a welcome message and ask for DTMF inputs, the audio file is played according to the provided input, the system asks for more DTMF inputs for more details and exit, for more information the end user provides DTMF input and for exit also it provides the input, if the end user is not providing any input then the IVR waits for a specified time and update the reward points & the call is disconnected. While providing DTMF inputs the system, when the user provides input to exit then the system updates the credit points and disconnect the call.

### Method for Providing Advertisement During Conference Call

As described in FIG. 11, for providing advertisement during a conference call, the advertiser has to upload the audio advertisement as per the category suitable for their business. This uploaded data is saved into database server, in this system when a user place a call, which lands on the IVR server, the IVR server captures the CLI and disconnect the call, and send to verify the CLI for registration, if caller is the registered then it fetches the list of contacts from the system. After that the dialler dials the captured CLI for call back to the CLI either it is registered or not. When the caller receives the call placed by IVRS, the IVR plays the Welcome Message and ask for input, if caller is the registered user then the caller can select contact number from the list if not registered then the caller enters the whole number. Then the IVR places a call to the contact number, in this duration till call is picked up or disconnect, the registered caller listens the advertise as per their category and unregistered caller listens to random advertisement. After connecting the call, the system joins both lines and advertisement background music is played during conversation or not played during conversation, and an advertisement is played for fixed duration during the call. After disconnecting the call, the system updates the database to credit the reward points. And the complete details is saved in to the system with the information of calling number and played advertisements with the time duration.

### Method for Providing Video Message Advertisement

With reference to FIG. 12, the method starts from the advertiser end, after successful verification the advertiser selects the category and upload the voice messages for that. After that these messages are verified by the service provider. At the mobile user end the registered mobile user dials a predefined number ######, after dialling this number by mobile user when the call touch to the IVR server, the IVR server captures the CLI and disconnect the call, after that system verifies the mobile number (in database). If CLI is registered then it searches the respective advertise (as per category criteria defined by mobile user) and if data is found then the system sends some advertisement video SMS to that CLI number. After getting the acknowledgement of that advertisement message from mobile user, it credits some points to the mobile user account. In the current system the advertiser can request to send video messages in bulk for the specified category.

### Method for Providing Wallpaper (Fixed and Sliding) Based Advertising

As referred to in FIG. 13, for providing the advertisement through wallpaper, the service runs at mobile end, this service is available on 3G/4G; GPRS enabled handsets. On GPRS, 3G and 4G enabled handsets the application can be installed if not installed. First the Advertiser has to upload wallpaper (fixed and sliding) and wait for service provider verification. After verification of service provider the wall paper gets activated. After activating it verifies that the user is subscribed for the wallpaper service or not, if subscriber subscribe for wallpaper then it checks for the wallpaper application installed or not if installed then it displays the Wallpaper (fixed and sliding) on the mobile screen, else if not installed it checks for download if downloaded than it installs the wallpaper application and after installation it can appear on the mobile screen, if not downloaded then it downloads and installs the wallpaper application and run on the mobile screen. After that it updates subscriber account to the mobile user account.

### Method for Providing Voice Message Advertisement

With reference to FIG. 14, the said method starts from the advertiser end, after successful verification the advertiser selects the category and uploads the voice messages for that. After that these messages are verified by service provider. And at the mobile user end the registered mobile user dials a predefined number ######, after dialling this number by mobile user when the call touch to the IVR server, the IVR server captures the CLI and disconnect the call, after that system verifies the mobile number (in database). If CLI is registered then it searches the respective advertise (as per category criteria defined by mobile user) and if data found then the system sends some advertisement voice SMS to that CLI number. After getting the acknowledgement of that advertisement message from mobile user, it will credit some points to the mobile user account. In the current system the advertiser can request to send voice messages in bulk for the specified category.

### Method for Providing Screen Saver Based Advertisement

Further as illustrated in FIG. 15, the service runs at mobile end, where the screen saver application is installed, it is not necessary to available the GPRS, 3G/4G technologies at the mobile end. This service is made available for both 3G/4G; GPRS enabled handsets as well as non GPRS and 3G/4G Technologies handsets.

For the non GPRS and non 3G/4G technologies the screen saver must be installed, and on GPRS, 3G and 4G enabled handsets the application can be installed. First the Advertiser uploads the data for Screen Saver and activated by the service provider. After activating it verifies that the user is subscribed for the service or not, if subscribes then it checks for the application installed or not; if installed then it will display the Screen Saver, else it will check for download if not downloaded than it will download and install, if downloaded then it will install the application and run the Screen Saver. After that it updates the subscriber account to the mobile user account.

### Method for Providing Scrolling Text Based Advertisement

Further as illustrated in FIG. 16, the service runs at mobile end, where the scrolling text application is installed, it is not necessary to available the GPRS, 3G/4G technologies at the mobile end. This service is available for both 3G/4G; GPRS enabled handsets as well as non GPRS and 3G/4G Technologies handsets. For the non GPRS and 3G/4G technologies the scrolling text application must be installed, and on GPRS, 3G and 4G enabled handsets the application can be installed. First the Advertiser has to upload the data for Scrolling Text and activated by the service provider. After activating it verifies that the user is subscribed for the service or not, if subscribes then it will check for the application installed or not if installed then it displays the scrolling text, else it checks for download if not downloaded than it downloads and install, if downloaded then it installs the application and run the scrolling text. After that it updates the subscriber account to the mobile user account.

### Method for Providing Dialer Ads Through IVRS

Further as illustrated in FIG. 17, the service runs at mobile end, where the screen For the Dialler based audio message advertisement the register user has to dial a predefine number ######, after dialling this number by mobile user when the call touches to the IVR server, the server captures the CLI and disconnect the call, after that system verifies the mobile number, If the CLI is not verified than either it terminates the request, or select a random advertisement and call back to the CLI, so the CLI user will be able to hear the advertisement, else If verified than it searches for the respective advertise (as per category criteria defined by mobile user) if advertise data not found than it sends an SMS to the CLI, else if found than it call back to that particular CLI number, and play the respective audio advertisement. If the CLI user wants to connect to advertiser he/she can connect to advertiser and resolve his/her query. After completion of dialler call to play the audio advertisement the IVR Server will pass a status of call completion. The respective engine updates it in the database with reward points.

### Method for Providing Text SMS

Further as illustrated in FIG. 18, the service runs at mobile end. For the text message the registered mobile user has to dial a predefined number ######, after dialing this number by mobile user when the call touch to the IVR server, the IVR server will capture the CLI and disconnect the call, after that system verifies the mobile number (in database) if not verified than the system sends any advertisement with a request for registration. If CLI is registered then it searches the respective advertise (as per category criteria defined by mobile user) and if advertise data not found than either it will not give any response to that CLI or either send a message “No Data Found Please Try Again Later.” for try again, else if data is found then the system sends some advertisement SMS to that CLI number. After getting the acknowledgement of that advertisement message from mobile user, it credit some points to the mobile user account.

### Method for Providing Credit Evaluation

For calculating the credit information as shown in FIG. 19, when the user dials a predefined number ######, after dialling this number by user when the call touch to the IVR server, the IVR server captures the CLI and disconnect the call, after that system verifies the mobile number (in database) if not verified than it will send a message for registration request else it checks for available balance as per credit points, if balance is not enough then it will send a message like Insufficient Fund, else if balance is available only then it will call back to the CLI and ask for the DTMF input as per the services offered by the service provider. After following the instructions the user can buy available services/goods as respective to the amount available in his account. After confirming the buying details the system will update the user account as per credit balance used.

### Method for Providing Phone Recharge/Bill Pay

For calculating the credit information as shown in FIG. 20, when the user needs recharge then the user ha to dial a predefined number ######, after dialling this number by user when the call touch to the IVR server, the IVR server will capture the CLI and disconnect the call, after that system will verify the mobile number (in database) if not verified than it will send a message as request for registration, else it will check for available balance as per credit points, if balance is available then it will find out the type of phone/mobile, for prepaid or post. If the phone/mobile number is prepaid then it will recharge as per balance available. Else if the phone/mobile is post paid then the respective amount will be paid to telecommunication service provider and will appear in next bill. After that the system will update the credit points in to user account.

### Method for Providing Pre Call Advertisement in Conference Call Placed by End User

As shown in FIG. 21, the method for providing pre call advertisements in conference call placed by end user, wherein the advertiser has to upload the advertisement as per the category suitable for their business. This uploaded data is saved into database server, in this system when a user place a call, the call is received by IVRS, the IVR server captures the CLI and send to verify the CLI for registration, if caller is the registered then it will fetch the list of contacts from the system, and the IVR will play the Welcome Message, the IVRS will play an advertisement. This advertisement will be optional service provider, after that the IVRS will ask for input, if caller is the registered user then the caller can select contact number from the list if not registered then the caller will enter whole number. Then the IVR will play an advertisement (optional for service provider) after the advertisement the IVRS will place the call through dialler to the contact number, in this duration till call picked up or disconnect, the registered caller will listen advertise as per their category and unregistered caller will listen random advertisement. After connecting the call the system will join both lines and advertisement background music will be played during conversation or not played during conversation, and an advertisement will play for fixed duration during the call. After disconnecting the call, the system will update the database to credit the reward points. And the complete details will be saved in to system with the information of calling number and played advertisements with the time duration.

### Method for Providing Pre Call Advertisement in Conference Call Back To End User

Further as shown in FIG. 22, which illustrates the pre call advertisement in a conference call back to the end user, wherein the advertiser has to upload the advertisement as per the category suitable for their business. This uploaded data is saved into database server, in this system when a user place a call, the call will land on IVR server, the IVR server will capture the CLI and disconnect the call, and send to verify the CLI for registration, if caller is the registered then it will fetch the list of contacts from the system. After that the dialler will dial the captured CLI for call back to the mobile user either it is registered or not. When the caller will receive the call placed by IVRS, and the IVR will play the Welcome Message, and the IVRS will play an advertisement. This advertisement will be optional for service provider, after that the IVRS will ask for input, if caller is the registered user then the caller can select contact number from the list if not registered then the caller will enter whole number. Then the IVR will play an advertisement (optional for service provider) after the advertisement the IVRS will place the call through dialler to the contact number, in this duration till call picked up or disconnect, the registered caller will listen advertise as per their category and unregistered caller will listen random advertisement. After connecting the call the system will join both lines and advertisement background music will be played during conversation or not played during conversation, and an advertisement will play for fixed duration during the call. After disconnecting the call, the system will update the database to credit the reward points. And the complete details will be saved in to system with the information of calling number and played advertisements with the time duration.

### Promotion Through Audio/Video Ring Tone & Phone Call

In addition to what has been disclosed in the above said paragraphs, the present invention also proposes to provide a method of playing of an advertisement without making a call and without receiving a phone call and end user can be rewarded for the credit points. In the current invention on the member requirement the registered mobile user will give a call to the specified number ######## when the call touch to the server, it will be disconnected by the server and server engine will capture the CLI of the caller. After that it will verify the CLI for is it registered or not, if this CLI is not registered then it will send an SMS “Please Become a Member First” to the respective CLI user, else if the captured CLI is registered with the service provider, then it will check the CLI for mobile type like (3G or GPRS or Video enabled handset or non 3G or non GPRS or non video enabled handset (Normal Phone) then the system will call back to the CLI, if the CLI user is using the phone who can play the video than the advertisement video ring tone will be played on their mobile, and user will be rewarded for the credit points. In case if the CLI user is using a normal phone then advertisement ring tone will be played and user will be rewarded for the credit points. And at the other end on the service provider or advertiser requirement, the a call will be placed to member, after placing the call the member phone will start ringing by advertisement ring tone audio or video as per handset, here either member can disconnect the call or service provider can disconnect or member can receive the call, while receiving the call will be disconnected or after receiving the call a message will be played and call will be disconnected, for this the member will be rewarded for credit points.

In addition it is also proposed that without making a call and receiving a phone call and end user can be rewarded for the credit points for both the conditions. In the current invention on the member requirement the registered mobile user will give a call to the specified number ########, when the call touch to the IVRS, the IVRS will capture the CLI of the caller and disconnect the call. After that it will verify the CLI for is it registered or not, if this CLI is not registered then it will send an SMS “Please Become a Member First” to the respective CLI user, else if the captured CLI is registered with the service provider, then it will check the CLI for mobile type like (3G or GPRS or Video enabled handset or non 3G or non GPRS or non video enabled handset (Normal Phone) and refine advertise data as per defined in user category, then the system will call back to the CLI, if the CLI user is using the video enabled phone than the advertisement video ring tone will be played on their mobile and after receiving the call the user will listen the advertisement, and user will be rewarded for the credit points for both scenarios listening advertisement and playing video advertisement file, in case if the CLI user is using a normal phone then advertisement audio ring tone will be played on their mobile and after receiving the call the user will listen the advertisement, and user will be rewarded for the credit points for both scenarios listening audio advertisement and playing ring tone as an advertisement. And at the other end on the service provider or advertiser requirement, the a call will be made to member, after placing the call the member phone will start ringing by audio/video advertisement ring tone as per using handset, here either member can disconnect the call or service provider can disconnect or member can receive the call, while receiving the call the refined advertisement data as category will be played as an advertisement, for both of the conditions the member will be rewarded with credit points.

Further in addition it is also proposed to play an advertisement in scheduling system, in this system the registered user can store their schedulers into system on the data and time basis. When the scheduler time matches with respective system time, then the dialler may dial a call to the registered user CLI and play the advertisement to the user. In the scheduler system the advertisement data can be audio file. When the call will connect to the respective user CLI, the audio or video ring tone advertisement will be played. And after receiving the call the user can hear the advertisement. This service can run as a scheduler from service provider end. The ring tone advertises data can also be a wake up message for the scheduler, as per the selected by user handset. After disconnecting the call the system can update the database for credit the reward points.

### Promotion Through SMS or Phone Call

The promotion of products, service providers, manufacturers, sellers, markets, malls, banks, stock holders, investments & financers, stores, cinema halls, movies, schools, colleges, book centres, institutes, hospitals, builders, shopping complex, business complex, travel, industries, marriage homes, community centres, farm houses, show rooms, consumer goods, athletic games and entertainment halls and so on. As per the invention the service provider may provide a unique telephone/mobile number or a unique short code to the each and every complex/mall. Therefore the promotion of such type of places can be done through phone calls, SMS IVR and other telecommunication devices.

In the system the end user can call to the service provider then either call will be received at service provider end or the system will capture the CLI and disconnect the call, after that the dialler will dial the captured CLI, after receiving the call by end user, the end user will get details of running events or ongoing offers inside the markets, products, service providers, manufacturers, sellers, malls, banks, consumer awareness, stock holders, investments & financers, stores, job placements, matrimonial, cinema halls, movies, schools, colleges, book centres, institutes, hospitals, builders, shopping complexes, business complexes, travels, industries, marriage homes, community centres, farm houses, show rooms, consumer goods, athletic games and entertainment halls and so on. Even the caller can directly connect to customer care by pressing a number X, to which the user was querying.

### Promotion Through SMS

When an end user will dial a number for such complex then the call will land on IVR server, after that the system will send SMS regarding that complex with their sub options and with new another numbers. After that when the end user call to the new number of the shop, then the system will send the SMS for products available in the shop with the available offers and new available brands and so on. If the end user having direct show room number then the end user will dial the showroom number then call will be disconnected by the system and that show room details will be send through SMS to the end user. The system will maintain the record for the se all details.

### Promotion Through Call

When an end user dials a number for such complex then the call will land on IVR server, after that the system will disconnect the call and the dialler will call back to the CLI or system receives the phone call, and play the options to get the details of the complex and after playing the options the system will wait for DTMF inputs after getting the input from end user the system will play the details in audio format. After that the system will wait for DTMF input for more details to provide to the end user. The system will maintain the record for the se all details, date time and time duration of the call and so on.

In the system there can be a one common number, by following the instruction and DTMF inputs the end user can move from one city to another city and one complex to complex inside the city and one shop to another shop in the complex. In the system the end user can provide direct extensions to the markets, products, service providers, manufacturers, sellers, malls, banks, consumer awareness, stock holders, investments & financers, stores, job placements, matrimonial, cinema halls, movies, schools, colleges, book centres, institutes, hospitals, builders, shopping complexes, business complexes, travels, industries, marriage homes, community centres, farm houses, show rooms, consumer goods, athletic games and entertainment halls and so on.

The system can be used as an alarm or a scheduler, in this section of the present invention the end user can store their personal data into the system as per the date and time. During the alarm of this personal information the system will play advertisement. The end user can modify or reschedule this alarm or scheduler information. This information will be stored in the system and will available on the end user request, before and after the schedule. For example—the end user can set their friend s birth day wishes, in this scenario the system will call to both the users and wishes the birthday and play jingle for that, in any moment of this jingle the system will play advertisement, related to the end user category. This scheduler can be used an account book for storing their transactions or any other data.

According to advertisements it is classified in to two classes, which are:

### Class A—Normal Phones (Non GPRS and Non 3G)

SMS text advertisement
Scrolling text
Screen saver
Voice message
Background advertisement
Precall ads
Caller tune
Dialer ads
   Class B—Advance Phones (With GPRS and 3G/4G technology)
Hyperlink advertisement
SMS text
Scrolling text
Screen saver
Caller tune
3G Video
Wallpaper (Fixed and Sliding)
Precall ads
Background
LBS (Local Based Service)
Voice message
Dialler ads
   The classification of main categories is as such
General Information: Occupation, age, sex, income, location, marital status, health, interested areas, Hobbies, dressing, pets & animals
Food & Other Habits: Food Habits, drinks, alcoholic, smoker.
Property: House, Vehicle, Computer, Servant, Appliances, Technology.
Reading: Books, magazines, Newspaper
Finance & Investment: Charity, Real Estate, Insurance, Banks, Investment, Bank cards.
Others: Medicines, Sports & Fitness, travel & tourism.
   All these mention categories consist of sub-categories and each individual category has further division as follows:

### General Information:

Occupation: Business, Professionals, Service person student, student as well Professional
Age: Teenager, adult, senior citizen
Sex: male, female
Income: Below 100000, 100000-200000, 200000-500000, 500000-10000000, above 10000000
Location: Rural, Urban, metropolitan
Marital status: Married, unmarried, divorcee
Health: Healthy, patient
Interested Areas: Music, entertainment, Reading Books, travelling, outdoors games, indoor games
Hobbies: Music, reading, surfing, watching TV, sports, indoor games, video games, cycling swimming
Dressing: western, traditional, ethnic, readymade, custom made, formal, casual
Pets & animals: Dog, cats, birds, others

### Food & Other Habits:

Food Habits: Vegetarian, Non-Vegetarian, Fast Food/Junk Food, Homemade, Eat Out, Snacks
Drinks: Fruit Juice, Health Drinks, Soft Drinks, Cold Drinks, Supplements, Shakes, Tea, Coffee
Alcoholic: Liquor, Wine, Beer, Others, Champaign, Vodka, Rum, Whisky, Tequila, Gin
Smoker: Smoking, Non-Smoking

### Property:

House: Rented, Own, PG
Vehicle: 2 Wheeler, 4 Wheeler, Commercial Vehicle, None
Computer: Desktop, Laptop, Printer
Servant: Maid, Servant, Housemaid, Watchman, Driver, Gardener, Peon
Appliances: TV, Refrigerator, Microwave OTG, Air Conditioner, Room Heater, Vacuum Cleaner, Dish Washer, Washing Machine, Iron
Technology: Internet, Mobile Phone, Dish TV

### Reading:

Books: Craft, Literature, History, Educational, Stories, Comics, Religious Books
Magazines: News, Sports, Automotive, Real Estate, Beauty, Current Events, Computers, Politics, Competitive, Interior Decoration, Jewellery, Fashion & Apparel
Newspaper: English, Hindi, Punjabi, Urdu, Bengali, Gujarati, Others

### Finance & Investment:

Charity: Old age Home, Orphanage, Widow Home, NGO, Social Services, CRY
Real Estate: Property, Flats, Apartment, Farm House, Home, Shop
Insurance: Death Accidental, Dismemberment Insurance, LIC
Banks: Private, Government, Corporate
Investment: Shares, Mutual Funds, Pension Plans, Stocks, Loans
Bank Cards: Credit Cards, ATM Cards, Debit Cards, Cash Cards, Travellers Cheque

### Others:

Medicines: Veterinary Medicines, Acupuncture, Homeopathic, Ayurveda, Naturopathic, Allopathic
Sports & fitness: Physical Fitness, Yoga, Gym, Aerobics
Travel & Tourism: Airlines, Trains, Roadways, Taxi, Personal Vehicle

All the classified details are recorded in the database-connected with the server. The server is also configured to transmit the advertisement, promotional details to the subscribers as per the entered and recorded classified details in the database. The server is also configured for fulfilling the subscriber/client requests, send installer to client, for the authentication purpose, to send SMS, ring tone, voice message and other services etc. and any changing regarding advertisement.

Server will automatically know about the uninstallation of application at client side. When client will uninstall the application then it will return a key to server. So that, server will know that client has uninstalled the application. If client has uninstalled as well delete the application but it has not unsubscribed, in that case server will send the installer at client side and install the application and if it has not deleted by client then install the application.

On the other hand, at client (mobile) side, here first installer will install the application and this application will provide services such as Scrolling text advertisement, screensaver, wallpaper, ringing tone etc.

We have two starting points. Through first point, we can insert the text advertisement and through other we can send the advertisements which are already present in our database. When we are inserting the advertisement, our application will automatically verify that advertisement does already exist in our database or not. If it is already present in our database then we show the advertisement is already in our database. When we ask to renew the advertisement, if answer is positive then only we will update the advertisements starting date, ending date and set its status. So then, processor as well as advertisement services will activate. If answer is negative so in that case ask for deletion. If says yes then delete it and exit but If says no then exit.

If advertisement does not exist then insert into database and set its starting date, ending date and set status. So, processor will activate and advertisement services as well. If all such advertisement services is activated then go for SMS, 3D VIDEO, VOICE MESSAGE, RING TONE if any of these are activated then it will check whether users is subscribed or not. If it is not then it will activate advertisement services. If yes then it will provide specific service. Further it will Check that whether advertisement is ring tone or not. If yes then start ringing at client side (on mobile). After that it will Check whether user has neglected the ring tone or not. If yes then start ringing otherwise it will stop ringing and activate advertisement services. Instead of all this, it will also check that time duration is not ended then continue ringing. If time duration comes to end then ringing will stop and activate advertisement services. If the entered advertisement is not one of these such as SMS, 3D VIDEO, VOICE MESSAGE, RING TONE and now we check the subscribers. If exists then we will check that application is installed or not, If not then installer will download automatically and install. If yes then it will activate the advertisement service. After activating the services, we will set wallpaper as well scrolling service.

If time duration of screensaver setting do not come at end and no interruption takes place in between then start screensaver. If any interrupt comes in between then running screensaver stops and start scrolling text advertisement as well as hide wallpaper.

If any call comes in between running scroll text, wallpaper and screensaver then all such service should stop. After that we will check whether subscriber have subscribed for precall tune service or not. If yes then it will start precall tune for predetermined time it will get stop and start ringing and caller tune service. If it is not being subscribed then it will directly start ringing and caller tune service.

If no call has not been received or dropped then ringing and caller tone service will be continued. If call has been received then in this case we will stop ringing as well as caller tone service and start background music. It will continue till the call ends up.

When call ends then immediately wallpaper and scrolling text will start.

The above mention details describe our present invention regarding advance technology of advertisement through mobiles/phones.

Hence, with such facilities the present invention would be beneficial for companies, general consumer and govt. as well.

### Beneficial for Companies

1. Large sale of product in less time.
2. Advertisement will be available to particular user on the basis of interested area.
3. It would be inexpensive and best.
4. Large production, due to fewer prices.
5. Facilities will provide according to particular area.
6. Direct contact with the customer is possible.
7. Small & new generate companies will grow in very short time.
8. In short duration and with less expense product will sale with high speed.

### Beneficial for General Consumer

1. User will get particular advertisement of their benefits.
2. User can store particular advertisement of their use and take advantage in future.
3. User can directly come in contact of us.
4. User can easily aware regarding advertisement of their benefits.

### Beneficial for Government

1. Advertisement will available at low price, so that product cost will be less automatically.
2. Through the advertisement, public may get emergency news.
   Finally, all such facilities enhance the use of this advertisement and because of its fewer prices it get popular in shortest time.

Although the foregoing description of the present invention has been shown and described with reference to particular embodiments and applications thereof, it has been presented for purposes of illustration and description and is not intended to be exhaustive or to limit the invention to the particular embodiments and applications disclosed. It will be apparent to those having ordinary skill in the art that a number of changes, modifications, variations, or alterations to the invention as described herein may be made, none of which depart from the spirit or scope of the present invention. The particular embodiments and applications were chosen and described to provide the best illustration of the principles of the invention and its practical application to thereby enable one of ordinary skill in the art to utilize the invention in various embodiments and with various modifications as are suited to the particular use contemplated. All such changes, modifications, variations, and alterations should therefore be seen as being within the scope of the present invention as determined by the appended claims when interpreted in accordance with the breadth to which they are fairly, legally, and equitably entitled.

1. A method of providing brand promotion via mobile communication terminal comprising a memory unit for storage of data, a display screen for viewing of images comprising the steps of: configuring a WAP server for sending an installation data to the subscribers mobile after verification of the authenticity of the subscribers; receiving advertisement image data from a WAP server; storing the advertisement multimedia contents as well as images and voice data in the memory unit; and outputting the advertisement stored in the memory on a predefined application of the mobile phone.

2. A method of providing brand promotion via mobile communication terminal as claimed in claim 1, wherein the advertisement is in the form of Caller Ring Back Tone, Customized Caller Tone, Customized Video Caller Tone, Video Ring Back Tone, Video Ring Tone, Ring Tone, Pre-Call Audio Message, Dialler Call, During Call in Conference, Mid Call, Video Message, Wallpaper (Fixed or Sliding), Audio Message, Screen Saver, Scrolling Text, Dialler based IVRS Call, Text Message, Multimedia Messages, 3G14G Video, SMS, MMS, Background music, Hyperlinks, Search Engine, Banner, Mobile Key Pad, Service message LBS (Location Based Service), USSD Message and Voice message as well as Bluetooth and Wi-Fi in a network and the like.

3. A method of providing brand promotion via mobile communication terminal as claimed in claim 1, wherein the storing of the image/voice data is allowed only after the verification of the WAP server as a rightful subscriber.

4. A method of providing brand promotion via mobile communication terminal as claimed in claim 1, wherein the outputting of advertisement is one selected from the application group consisting at least of: play an audio/video/text advertisement through mobile, play multimedia clip and background music on mobile phones as an advertisement when user commence a call with their mobile terminals and provide a customized advertisement through playing music and sound in background when someone places a phone call.

5. A method of providing brand promotion via mobile communication terminal as claimed in claim 1, wherein the customized advertisement for predetermined time is generated during caller tone without interrupting in user's call to enable a caller to listen and watch the customized audio/video advertisement as per his own desire.

6. A method of providing brand promotion via mobile communication terminal as claimed in claim 1, wherein the outputting of advertisement is one selected from the application group consisting at least of: between conversation of subscribers of CRBT members; IVRS & dialler based voice file called by end user; during conference call; pre call advertisement in conference call placed by end user; pre call advertisement in conference call back to end user.

7. A method of providing brand promotion via mobile communication terminal as claimed in claim 1, wherein the WAP server is configured for automatically detecting about any installation/uninstallation of application from subscribers mobile.

8. A method of providing brand promotion via mobile communication terminal as claimed in claim 1, wherein the WAP server further comprises a database for the recordal of the data of clients, data related to the advertisements, updated advertisement status of the subscribers, time of usage of the advertisement of each subscriber and thereby providing advantages designated with respect to the number of the listening and watching of the selected advertisement.

9. A method of providing brand promotion via mobile communication terminal comprising a memory unit for storage of data, a display screen for viewing of images substantially such as herein described along with the accompanying drawings.

10. A mobile phone configured for processing the method of providing brand promotion as claimed in claim 1.
